(19) United States
(12) Patent Application Publication
(10) Pub. No.: US 2019/0122382 A1
(43) Pub. Date: Apr. 25, 2019

(54) METHOD AND APPARATUS THAT DISPLAY VIEW ALERT

(71) Applicant: GM GLOBAL TECHNOLOGY OPERATIONS LLC, Detroit, MI (US)

(72) Inventors: Yue Fan, Troy, MI (US); Mike Aljamal, Macomb, MI (US); Zachary S. Mendla, Shelby Township, MI (US)

(21) Appl. No.: 15/791,689

(22) Filed: Oct. 24, 2017

(51) Int. Cl. G06T 7/73; B60R 1/00; G06T 7/246; G01P 15/08

(52) U.S. Cl. CPC G06T 7/74; B60R 1/00; G06T 7/248; G06T 2207/30244; B60R 2300/60; G06T 2207/30252; G01P 15/0802

(57) ABSTRACT

A method and apparatus that display a view alert are provided. The method includes determining that information of a sensor is being provided, in response to determining that the information of the sensor is being provided, determining whether an angle or field of view of the sensor is correctly oriented, and in response to determining that the angle or field of view of the camera is incorrectly oriented, providing an alert indicating that the angle or field of view of the camera is incorrectly oriented.

### INTRODUCTION

Apparatuses and methods consistent with exemplary embodiments relate to sensors and alerts. More particularly, apparatuses and methods consistent with exemplary embodiments relate to displaying alerts about sensors.

### SUMMARY

One or more exemplary embodiments provide a method and an apparatus that detect an orientation of a sensor and display an alert regarding the orientation of the sensor. More particularly, one or more exemplary embodiments provide a method and an apparatus that display an alert regarding an incorrectly oriented camera providing an image of an area outside of a vehicle.

According to an aspect of an exemplary embodiment, a method for displaying a view alert is provided. The method includes determining that information of a sensor is being provided, in response to determining that the information of the sensor is being provided, determining whether an angle or field of view of the sensor is correctly oriented; and in response to determining that the angle or field of view of the camera is incorrectly oriented, providing an alert indicating that the angle or field of view of the camera is incorrectly oriented.

The displaying the alert may include one or more from among overlaying the alert over an image provided by the camera on a display, a blinking screen, a blank screen with an alert, or an animation.

The sensor may be a camera of a vehicle disposed on a trunk, hood, a tailgate, or a lift-gate of the vehicle.

The determining that information of the sensor is to be provided may be performed by detecting a transition of a vehicle into a reverse movement state

The determining whether the angle or field of view of the sensor is correctly oriented may include detecting a status of a switch indicating whether a trunk, a tailgate, a hood, or a lift-gate is ajar.

The determining whether the angle or field of view of the sensor is correctly oriented may include determining a position or a size of a light captured by the sensor and comparing the determined position or size to a calibrated position or size.

The determining whether the angle or field of view of the sensor is correctly oriented may include determining a position of the sensor based on accelerometer information captured by an accelerometer disposed on a trunk, a hood, a tailgate, a lift-gate or the camera.

The determining whether the angle or field of view of the sensor is correctly oriented may include analyzing a first image of the camera to determine whether features of a second image of a correct field of view are present in the first image and positioned in a same location as the second image.

The features may include fixed elements of a vehicle.

According to an aspect of exemplary embodiment, an apparatus that displays a view alert is provided. The apparatus includes at least one memory comprising computer executable instructions; and at least one processor configured to read and execute the computer executable instructions. The computer executable instructions may cause the at least one processor to determine that information of a sensor is to be provided, in response to determining that the information of the sensor is being provided, determine whether an angle or field of view of the sensor is correctly oriented, and in response to determining that the angle or field of view of the sensor is incorrectly oriented, provide an alert indicating that the angle or field of view of the sensor is incorrectly oriented.

The computer executable instructions may cause the at least one processor to provide the alert by performing one or more from among overlaying the alert over an image provided by the camera on a display, a blinking screen, a blank screen with an alert, or an animation.

The sensor may be a camera of a vehicle disposed on a trunk, hood, a tailgate, or a lift-gate of the vehicle.

The computer executable instructions may cause the at least one processor to determine that information of the sensor is to be provided by detecting a transition of a vehicle into a reverse movement state.

The computer executable instructions cause the at least one processor to determine whether the angle or field of view of the sensor is correctly oriented by detecting a status of a switch indicating whether a trunk, a tailgate, a hood or a lift-gate is ajar.

The computer executable instructions may cause the at least one processor to determine whether the angle or field of view of the sensor is correctly oriented by determining a position or a size of a light captured by the sensor and comparing the determined position or size to a calibrated position or size.

The computer executable instructions may cause the at least one processor to determine whether the angle or field of view of the sensor is correctly oriented by determining a position of the sensor based on accelerometer information captured by an accelerometer disposed on a trunk, a hood, a tailgate, a lift-gate or the camera.

The computer executable instructions may cause the at least one processor to determine whether the angle or field of view of the sensor is correctly oriented by analyzing a first image of the sensor to determine whether features of a second image of a correct field of view are present in the first image and positioned in a same location as the second image.

The features may include fixed elements of a vehicle.

The apparatus may include the sensor, the sensor including a camera configured to capture the information including image information of an area around a vehicle.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that displays a view alert according to an exemplary embodiment;

FIG. 2 shows a flowchart for a method of displaying a view alert according to an exemplary embodiment;

FIG. 3 shows an illustration of a correct and incorrect orientation of a view according to an aspect of an exemplary embodiment; and

FIG. 4 shows illustrations of a camera and a field of view according to an aspect of an exemplary embodiment.

### DETAILED DESCRIPTION OF EXEMPLARY EMBODIMENTS

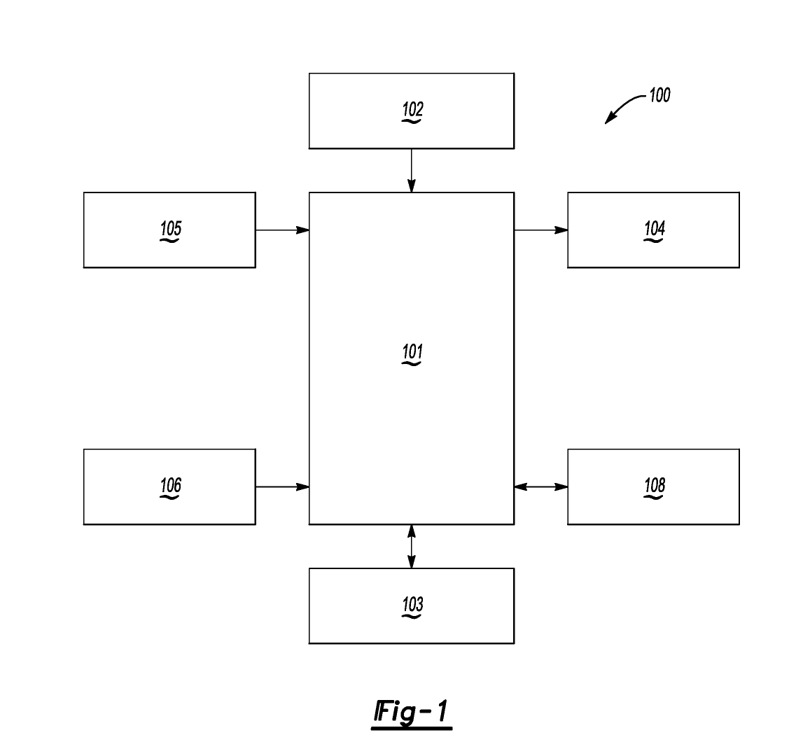

An apparatus and method that provide view alerts will now be described in detail with reference to FIGS. 1-4 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Vehicles such as trucks or other machines may include displays or other indicators that provide views of or information about an area outside of the vehicle or machine. The display may display an image of an area around the vehicle captured by a camera or sensor facing the area outside of the vehicle. Examples of displays may include a center stack display, a side mirror display or a rear view mirror display that output the image provided by a camera facing the area behind the vehicle or machine. These displays and cameras may be used to guide the vehicle or machine to a location or a position.

The display may overlay guidelines or graphical elements on the displayed image of the area outside of the vehicle to assist an operator in directing, positioning, guiding or steering a vehicle or to notify an operator of hazard. The image of the area outside of the vehicle may be provided by, in one example, a rear view camera such as a rear vision back up camera located on a tailgate, lift-gate, a trunk, or bumper of a vehicle. The guidelines or graphical elements may animated or transformed to reflect the direction, position, movement or potential movement of the vehicle as well as the slope, vertical profile, shape, topography of the path of travel of the vehicle.

FIG. 1 shows a block diagram of an apparatus that displays a view alert 100 according to an exemplary embodiment. As shown in FIG. 1, the apparatus that displays a view alert 100, according to an exemplary embodiment, includes a controller 101, a power supply 102, a storage 103, an output 104, a sensor 105, a user input 106, and a communication device 108. However, the apparatus that displays a view alert 100 is not limited to the aforementioned configuration and may be configured to include additional elements and/or omit one or more of the aforementioned elements. The apparatus that displays a view alert 100 may be implemented as part of a vehicle, as a standalone component, as a hybrid between an on vehicle and off vehicle device, or in another computing device.

The controller 101 controls the overall operation and function of the apparatus that displays a view alert 100. The controller 101 may control one or more of a storage 103, an output 104, a sensor 105, a user input 106, and a communication device 108 of the apparatus that displays a view alert 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 may be configured to send and/or receive information from one or more of the storage 103, the output 104, the sensor 105, the user input 106, and the communication device 108 of the apparatus that displays a view alert 100. The information may be sent and received via a bus or network, or may be directly read or written to/from one or more of the storage 103, the output 104, the sensor 105, the user input 106, and the communication device 108 of the apparatus that displays a view alert 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the sensor 105, the user input 106, and the communication device 108, of the apparatus that displays a view alert 100. The power supply 102 may include one or more from among a battery, an outlet, a capacitor, a solar energy cell, a generator, a wind energy device, an alternator, etc.

The storage 103 is configured for storing information and retrieving information used by the apparatus that displays a view alert 100. The storage 103 may be controlled by the controller 101 to store information received from the sensor 105 and to retrieve the stored information. The storage may store sensor information such as image information, movement information corresponding to the sensor or a body part of a vehicle or machine, and switch information corresponding to whether a door, trunk, lift-gate, hood, or tailgate is ajar, open or closed. In addition, the storage 103 may also include computer instructions configured to be executed by a processor to perform the functions of the apparatus that displays a view alert 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that displays a view alert 100. The output 104 may include one or more from among a speaker, an audible transducer, a display, a centrally-located display, a head up display, a windshield display, a haptic feedback device, a vibration device, a tactile feedback device, a tap-feedback device, a holographic display, an instrument light, an instrument panel display, a center stack display, a rear view mirror display, a side view mirror display, an indicator light, etc.

According to one example, the output 104 may be one or more from among a center stack display, a side mirror display, or a rear view mirror display. The output 104 may be configured to output an image or other information from the sensor 105 and output an alert or notification onto the image or information or corresponding to the image or information. The In addition, the output 104 may output the notification or alert including one or more from among an audible notification, a light notification, and a display notification. The alert or notification may indicate that the sensor 105 is incorrectly oriented or aligned, or that the field of view of the sensor 105 outside of or not aligned with a calibrated or correct field of view.

The user input 106 is configured to provide information and commands to the apparatus that displays a view alert 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104.

The sensor 105 may be one or more of a rear facing camera, a camera, an infrared camera, a night vision camera, an ultrasonic sensor, a radar, an accelerometer, an infrared sensor, a laser sensor, a LIDAR, etc. According to an example, the sensor 105 may be a rear view camera mounted on a tailgate of a truck, a rear view mirror, a hood, a dashboard, a side view mirror, a trunk, a high mount stop light or a bumper of the vehicle or machine. The images or information from the sensor 105 may be analyzed to determine whether the sensor is correctly oriented.

The communication device 108 may be used by apparatus that displays a view alert 100 to communicate with various types of external apparatuses according to various communication methods. The communication device 108 may be used to receive image information, topographical information or vertical profile information from the sensor 105. In addition, the communication device 108 may be used to send image information to the output 104 to display the image information and the generated guidelines that are overlaid onto the image information.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

According to an example, the controller 101 of the apparatus that displays a view alert 100 may be configured to determine that information of a sensor is to be provided, in response to determining that the information of the sensor is being provided, determine whether an angle or field of view of the sensor is correctly oriented, and in response to determining that the angle or field of view of the sensor is incorrectly oriented, provide an alert indicating that the angle or field of view of the sensor is incorrectly oriented.

The sensor may be a camera of a vehicle disposed on a trunk, hood, a tailgate, or a lift-gate of the vehicle. The controller 101 may provide the alert by overlaying an image of the alert over an image provided by the sensor on a display. The controller 101 may be configured to determine that information of the sensor is to be provided by detecting a transition of a vehicle into a reverse movement state.

According to an example, the controller 101 of the apparatus that displays a view alert 100 may be configured to determine whether the angle or field of view of the sensor is correctly oriented by detecting a status of a switch indicating whether a trunk, a tailgate, a hood or a lift-gate is ajar. According to another example, the controller 101 of the apparatus that displays a view alert 100 may be configured to determine whether the angle or field of view of the sensor is correctly oriented by determining a position or a size of a light captured by the sensor and comparing the determined position or size to a calibrated position or size. According to yet another example, the controller 101 of the apparatus that displays a view alert 100 may be configured to determine whether the angle or field of view of the sensor is correctly oriented by determining a position of the sensor based on accelerometer information captured by an accelerometer disposed on a trunk, a hood, a tailgate, a lift-gate or the camera.

According to yet another example, the controller 101 of the apparatus that displays a view alert 100 may be configured to determine whether the angle or field of view of the sensor is correctly oriented by analyzing a first image of the sensor to determine whether features of a second image of a correct field of view are present in the first image and positioned in a same location as the second image. The features may include fixed elements of a vehicle. Examples of fixed elements may include a bumper of a vehicle, a vehicle panel, lights of a vehicle, etc.

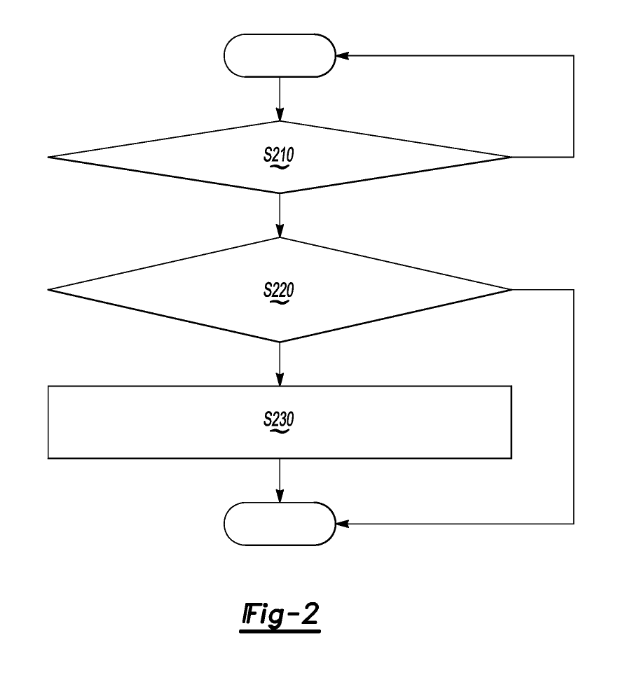

FIG. 2 shows a flowchart for a method of displaying a view alert according to an exemplary embodiment. The method of FIG. 2 may be performed by the apparatus that displays a view alert 100 or may be encoded into a computer readable medium as instructions that are executable by a computer to perform the method.

Referring to FIG. 2, it is determined whether sensor information is to be provided or displayed in operation S210. In this case, sensor information may be image information from a camera capturing an image of an area around a vehicle. Moreover, the determination that the information will be provided can include detecting information being received from the camera or sensor, detecting a shift of the vehicle transmission into a reverse state or other state, detecting a user input to select an option to display an image or information from the sensor or camera.

In operation S220, it is determined whether the field of view or orientation of the sensor or camera is correct. For example, it can be determined that the camera is tilted to far upward, to far downward, or to the right or left. This can occur when a trunk, lift-gate, tailgate, hood or other vehicle hatch, door, or moving body part is moved out of a default position from which the information from the sensor or camera is to be provided and displayed. The determination of whether the orientation is correct or not can be made by analyzing a door switch, analyzing fixed features of an image or information provided by the sensor or camera, or analyzing a light of an image or information provided by the sensor or camera.

If it is determined that the sensor orientation or field of view of the sensor is incorrect, an alert is provided to alert an occupant or operator that the incorrect field of view or sensor orientation in operation S230. The alert may be provided in the form of one or more from among an instrument light, an audible alert, on a display over a displayed image or displayed information from the sensor or camera, or other suitable form.

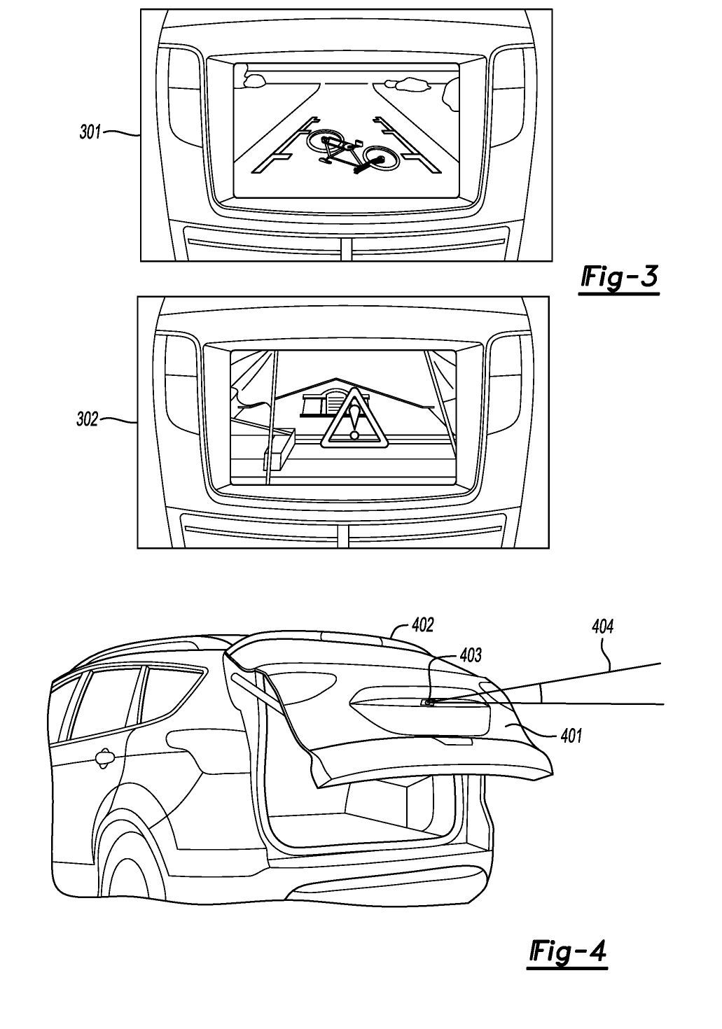

FIG. 3 shows an illustration of a correct and incorrect orientation of a view according to an aspect of an exemplary embodiment. Referring to FIG. 3, illustration 301 shows information or an image from a correctly oriented camera or sensor. The illustration shows an image from a rear-facing camera showing the path behind the vehicle as well as an obstacle, (e.g., a bicycle) in the path behind the vehicle.

Illustration 302 shows what can happen when a sensor or camera is incorrectly oriented. In this case, the image from the camera shows a sky and a top of the house. However, the path or road around the vehicle is not shown because it is out of the field of view of the incorrectly angled or oriented camera. This may be due to vehicle door or part on which the camera is mounted being ajar.

FIG. 4 shows illustrations of a camera and a field of view according to an aspect of an exemplary embodiment. Referring to FIG. 4, an example of a vehicle 400 with a movable body part 401 (in this case, a lift-gate or trunk) is shown. The camera or sensor providing information or an image of an area outside of a vehicle may be disposed in area 402 or 403.

When the movable body part 401 is ajar, the field of view 404 or viewing angle of the sensor or camera 402 and 403 becomes incorrectly oriented. Thus, the information provided form the sensor or camera 402 and 403 may not be complete or may be unusable. Thus, an occupant or operator of the vehicle may be warned that the field of view 404 or viewing angle of the sensor or camera 402 and 403 is incorrect.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for displaying a view alert, the method comprising:
determining that information of a sensor is being provided;
in response to determining that the information of the sensor is being provided, determining whether an angle or field of view of the sensor is correctly oriented; and
in response to determining that the angle or field of view of the camera is incorrectly oriented, providing an alert indicating that the angle or field of view of the camera is incorrectly oriented.

2. The method of claim 1, wherein the displaying the alert comprises one or more from among overlaying the alert over an image provided by the camera on a display, a blinking screen, a blank screen with an alert, or an animation.

3. The method of claim 1, wherein the sensor is a camera of a vehicle disposed on a trunk, hood, a tailgate, or a lift-gate of the vehicle.

4. The method of claim 1, wherein the determining that information of the sensor is to be provided by detecting a transition of a vehicle into a reverse movement state.

5. The method of claim 1, wherein the determining whether the angle or field of view of the sensor is correctly oriented comprises detecting a status of a switch indicating whether a trunk, a tailgate, a hood, or a lift-gate is ajar.

6. The method of claim 1, wherein the determining whether the angle or field of view of the sensor is correctly oriented comprises determining a position or a size of a light captured by the sensor and comparing the determined position or size to a calibrated position or size.

7. The method of claim 1, wherein the determining whether the angle or field of view of the sensor is correctly oriented comprises determining a position of the sensor based on accelerometer information captured by an accelerometer disposed on a trunk, a hood, a tailgate, a lift-gate or the camera.

8. The method of claim 1, wherein the determining whether the angle or field of view of the sensor is correctly oriented comprises analyzing a first image of the camera to determine whether features of a second image of a correct field of view are present in the first image and positioned in a same location as the second image.

9. The method of claim 8, wherein the features comprise fixed elements of a vehicle.

10. A non-transitory computer readable medium comprising computer executable instructions executable by a processor to perform the method of claim 1.

11. An apparatus that displays a view alert, the apparatus comprising:
at least one memory comprising computer executable instructions; and
at least one processor configured to read and execute the computer executable instructions, the computer executable instructions causing the at least one processor to:
determine that information of a sensor is to be provided;
in response to determining that the information of the sensor is being provided, determine whether an angle or field of view of the sensor is correctly oriented; and
in response to determining that the angle or field of view of the sensor is incorrectly oriented, provide an alert indicating that the angle or field of view of the sensor is incorrectly oriented.

12. The apparatus of claim 11, wherein the computer executable instructions cause the at least one processor to provide the alert by performing one or more from among overlaying the alert over an image provided by the camera on a display, a blinking screen, a blank screen with an alert, or an animation.

13. The apparatus of claim 11, wherein the sensor is a camera of a vehicle disposed on a trunk, hood, a tailgate, or a lift-gate of the vehicle.

14. The apparatus of claim 11, wherein the computer executable instructions cause the at least one processor to determine that information of the sensor is to be provided by detecting a transition of a vehicle into a reverse movement state.

15. The apparatus of claim 11, wherein the computer executable instructions cause the at least one processor to determine whether the angle or field of view of the sensor is correctly oriented by detecting a status of a switch indicating whether a trunk, a tailgate, a hood or a lift-gate is ajar.

16. The apparatus of claim 11, wherein the computer executable instructions cause the at least one processor to determine whether the angle or field of view of the sensor is correctly oriented by determining a position or a size of a light captured by the sensor and comparing the determined position or size to a calibrated position or size.

17. The apparatus of claim 11, wherein the computer executable instructions cause the at least one processor to determine whether the angle or field of view of the sensor is correctly oriented by determining a position of the sensor based on accelerometer information captured by an accelerometer disposed on a trunk, a hood, a tailgate, a lift-gate or the camera.

18. The apparatus of claim 11, wherein the computer executable instructions cause the at least one processor to determine whether the angle or field of view of the sensor is correctly oriented by analyzing a first image of the sensor to determine whether features of a second image of a correct field of view are present in the first image and positioned in a same location as the second image.

19. The apparatus of claim 18, wherein the features comprise fixed elements of a vehicle.

20. The apparatus of claim 11, further comprising the sensor, the sensor comprising a camera configured to capture the information including image information of an area around a vehicle.
